(19) United States
(12) Patent Application Publication
(10) Pub. No.: US 2026/0194715 A1
(43) Pub. Date: Jul. 9, 2026

(54) METHOD FOR PRODUCING AN OPTICAL STRUCTURE AND OPTICAL STRUCTURE

(71) Applicant: Meta Platforms Technologies, LLC, Menlo Park, CA (US)

(72) Inventors: Osman Acer, Turnhout (BE); Daniel Puskas, Eindhoven (NL)

(21) Appl. No.: 18/802,911

(22) PCT Filed: Dec. 28, 2022
(86) PCT No.: PCT/EP2022/087965

§ 371 Date: Aug. 13, 2024

(30) Foreign Application Priority Data
Feb. 18, 2022 (EP) 22157557.4

(51) Int. Cl. G02B 6/124; B41M 3/00; B41M 5/00; B41M 7/00

(52) U.S. Cl. CPC G02B 6/124; B41M 3/003; B41M 3/008; B41M 5/0047; B41M 7/0081

(57) ABSTRACT

A method for producing an optical structure including at least one optical microstructure includes: providing a base structure, printing at least one template structure on the base structure, where the template structure is built up from at least one droplet of printing ink, printing a smoothing layer at least on top of the template structure, curing the smoothing layer, where during the printing and/or curing of the smoothing layer parameters of the printing process and/or the curing process are chosen such that the smoothing layer includes on its outer surface an optical microstructure at a position vertically above the template structure, where the optical microstructure has a height that is lower than a height of the template structure.

### CROSS-REFERENCE TO RELATED APPLICATIONS

This application is a national stage entry under 35 U.S.C. 371 of PCT Patent Application No. PCT/EP2022/087965, filed Dec. 28, 2022, which claims priority to European Patent Application No. 22157557.4, filed Feb. 18, 2022, the entire contents of each of which are incorporated herein by reference.

### BRIEF DESCRIPTION OF THE DRAWING

FIG. 1 shows an optical structure produced by a method according to an advantageous embodiment.

### DETAILED DESCRIPTION OF EXEMPLARY EMBODIMENTS

The present disclosure relates to a method for producing an optical structure including at least one optical microstructure, in particular a micro-lens.

Such optical structures may be used, e.g., as lenses. In recent years, with the rise of rapid prototyping and in particular additive manufacturing, it has been shown that such optical structures can easily be produced, e.g., by three-dimensional printing. They may be produced highly customized and may include additional structures.

It is desirable, e.g., for ophthalmic lenses, microscopy or semiconductor production, to create optical microstructures with very small dimensions, e.g., in the region of microns or even nanometers.

Yet, this poses problems for the current three-dimensional printing technology as the structures that may be printed by modern 3D-printers are larger than those required for such microstructures (wherein the term microstructure is used to denote smaller structures, such as nanostructures, as well).

Therefore, in order to produce the desired microstructures, lots of efforts go into the task of producing smaller droplet sizes.

Hence, it is a purpose of the present disclosure to provide a method for producing an optical structure including at least one optical microstructure, in particular a micro-lens, which is repeatable and easy and allows for the production of different microstructures.

According to certain embodiments, this may be achieved by a method for producing an optical structure including at least one optical microstructure, in particular a micro-lens,
wherein in a first step, a base structure is provided,
wherein in a second step, at least one template structure is printed on the base structure, wherein the template structure is built up from at least one droplet of printing ink, in particular from at least one layer of printing ink deposited through targeted placement of droplets of printing ink at least partially side by side,
wherein in a third step, a smoothing layer is printed at least on top of the template structure, wherein the smoothing layer is built up from at least one layer of printing ink deposited through targeted placement of droplets of printing ink at least partially side by side,
wherein in a fourth step, the smoothing layer is cured,
wherein during the third step and/or the fourth step, parameters of the printing process and/or the curing process are chosen such that the smoothing layer includes on its outer surface an optical microstructure at a position vertically above the template structure, wherein the optical microstructure has a height which is lower than a height of the template structure.

The disclosed method advantageously allows for a particularly easy way to produce microstructures such as micro-lenses without the need to modify the existing three-dimensional printers. In particular, the applicant discovered that surprisingly, smaller sized structures, in particular microstructures, may be accurately produced by printing a larger template structure and applying a smoothing layer on this structure. It is hence advantageously possible to create structures with small structural sizes, e.g., micro-lenses.

The embodiments and advantages described in conjunction with this subject matter of the present disclosure also apply to the further subject matter of the present disclosure and vice versa.

The optical structure is a three-dimensional structure preferably intended to at least partially transmit light. The optical structure is more preferably intended for use with the visible spectrum. Preferably, in order to serve an optical purpose, the optical structure is at least partially optically transparent, in particular at least for a predetermined range of wavelengths, such as the visible spectrum.

As mentioned above, within the context of this application, the term “microstructures” is not intended to be limited to structures with sizes in the range of several micrometers, but also smaller structures with sizes in the range of several nanometers, i.e., nanostructures. Furthermore, the term microstructure is used within the scope of this disclosure synonymously with the term optical microstructure.

Preferably, the shape of the microstructure corresponds substantially to the general shape of the template structure, e.g., in the simple case of a substantially dome-shaped template structure, the microstructure will preferably also include a dome shape, but with different dimensions and in particular a smaller height. Thus, advantageously, a template structure can be conventionally printed with heights of about a few hundred or thousands of nanometers, and the resulting microstructure may include a height of only a few, e.g., tens, of nanometers.

According to the disclosure, the template structure includes at least one droplet of printing ink, which is preferably deposited at a predetermined location by means of targeted placement. Preferably, the template structure includes at least one layer of printing ink deposited through targeted placement of droplets of printing ink at least partially side by side. The template structure may as well include more than one layer, wherein consecutive layers are at least partially printed on top of the previous layer.

According to a preferred embodiment, the base structure, the template structure and/or the smoothing layer are at least partially printed in a multi-pass printing mode, wherein preferably a layer printed in a multi-pass printing mode includes multiple sublayers which are printed in subsequent sublayer printing steps, where at least one sublayer printing step is followed by an at least partial curing step. This allows in a very advantageous manner for a highly flexible and customizable production of optical structures, in particular including microstructures such as a micro-lens.

A multi-pass printing mode preferably includes the printing head making several passes, in particular back and/or forth, wherein during each pass, a sublayer of the layer is printed. Each sublayer may be subjected to a separate curing step, only the completed layer may be subjected to a curing step, or a curing step is performed in regular or irregular intervals, e.g., as soon as a predetermined amount of sublayers are printed and/or after a predetermined time after printing has passed. Alternatively or additionally, at least one layer of the base structure, the template structure and/or the smoothing layer is printed in a multi-pass printing mode, wherein at least one further layer is printed in a non-multi-pass printing mode. By including a multi-pass printing mode, it is advantageously possible to correct errors in the optical structure. This process is detailed in EP 3722073A 1. The disclosure of the aforementioned application, at least regarding the application of a multi-pass printing mode for approximation error reduction, is incorporated by reference in the present disclosure.

According to a preferred embodiment, an additional curing step is carried out after the first step and/or after the second step. In particular, curing sub-steps may generally be performed at any time in the process, e.g., a partial curing may be carried out after finishing printing a layer. Preferably, a layer is at least partially cured before a subsequent layer is printed. More preferably, an element of the optical structure, i.e., in particular the base structure, the template structure and/or the smoothing layer, is substantially fully cured before the subsequent element (i.e., the template structure and/or the smoothing layer) is printed. This advantageously allows for a precise shaping of the optical structure. On the other hand, printing a layer on top of a not-fully cured layer may advantageously improve the bonding between the layers or elements.

According to a further preferred embodiment, in an additional step between the second step and the third step, the template structure is at least partially cured. The shape of the template structure and/or the bonding with the base structure and/or the smoothing layer may thus advantageously be tuned.

Printing of an optical structure may include building up the structure from layers of printing ink. These are obtained through a targeted placement of droplets of printing ink at least partially side by side. The droplets of printing ink are preferably ejected from nozzles of a print head, typically in a substantially vertical direction towards a substrate or a base structure, though ejecting at an angle is possible as well. Droplets of layers constituting the following layer are at least partly ejected towards the previously deposited layer, such that the three-dimensional structure is built up layer by layer. Preferably, the three-dimensional printing is a multi-jet printing.

Preferably, the printing ink includes a translucent or transparent component. More preferably, the printing ink includes at least one photo-polymerizable component. The at least one photo-polymerizable component is most preferably a monomer that polymerizes upon exposure to radiation, e.g., ultra-violet (UV) light. The deposited droplets are preferably pin cured, i.e., partially cured, after deposition. More preferably, the viscosity of at least one component of the printing ink is increased. Pin curing is most preferably carried out after deposition of the respective droplet or after deposition of an entire or only part of a layer. Alternatively, pin curing is carried out at certain intervals, e.g., after printing of every second layer. In particular for an optical component and/or an optical structure, it is desirable that the structure is at least partly translucent and/or transparent. Preferably, curing may include actively and/or passively curing, wherein in particular passively curing includes letting the droplets dry or cure over time, whereas actively curing includes acting upon the deposited droplets, e.g., submitting the droplets to additional energy such as electromagnetic radiation, in particular UV light.

According to a preferred embodiment, the parameters of the printing process include at least one of an ambient temperature, a temperature of the printing ink, a composition of the printing ink, a viscosity of the printing ink, a droplet size, a droplet ejection velocity, a droplet density and a printing velocity, and/or the parameters of the curing process include at least one of a curing temperature, a curing time, an irradiation intensity and an irradiation wavelength. In accordance with certain embodiments, at least one of those parameters is adjusted such as to create the optical microstructure, in particular with predetermined dimensions. It is hence advantageously possible to obtain a microstructure with predetermined dimensions and properties. For example, by choosing the parameters accordingly, an improved scratch resistance of the optical structure, in particular the smoothing layer, may be obtained.

According to still another preferred embodiment, a different ink is used for printing the smoothing layer and for printing the template structure. In particular, the printing inks used for the base structure, the template structure and/or the smoothing layer include at least one different parameter, wherein the parameter is at least one of glass transition temperature, elasticity, thermal coefficient, viscosity, refractive index, dispersion, transmission coefficient, absorption, reflection coefficient and color, wherein in particular the printing ink used for the template structure includes at least one parameter which is different from that of the printing ink used for the smoothing layer and hence the optical microstructure. Hence, by printing the layers according to predetermined shapes and/or thicknesses and preferably with different inks, the mechanical and optical properties of the resulting optical structure can advantageously be tuned as desired. Using printing inks with different properties is a particularly easy and therefore advantageous way to obtain the desired microstructure.

In certain instantiations, the dimensions of structures and elements include, but are not limited to, a height, i.e., a vertical extension perpendicular to the area of the base structure, and a lateral width, i.e., a horizontal extension parallel to the area of the base structure. The person skilled in the art understands that the template structure and/or the microstructure may include substantially any outer contour and/or shape as desired and that in particular, the template structure and/or the microstructure may include varying heights and/or different lateral widths in different orientations. For the sake of simplicity, for all intents and purposes only a height, which is preferably indicative of a maximum height, and a lateral width, which is preferably indicative of a maximum lateral width, is referred to. This scope of various embodiments shall explicitly not be construed as being limited to structures with a uniform height and/or a uniform lateral width. Instead, other and in particular more complex shapes are encompassed by the present disclosure as well. All corresponding explanation apply equivalently. In particular, a height of the template structure indicates a vertical extension from an (assumed) flat surface of the base structure to the highest point of that template structure, and/or height of the microstructure indicates a vertical extension from an (assumed) flat surface of the smoothing layer to the highest point of that microstructure. In particular, the height of the microstructure is different from the (maximum) thickness of the smoothing layer.

According to a preferred embodiment, the base structure is a substrate, a lens blank and/or a three-dimensionally printed structure. In particular, the base structure may include a base layer printed upon a substrate. This is particularly advantageous as the resulting base structure may be produced such as to include a very smooth surface, which is of particular importance when creating optical microstructures. Furthermore, the material of the base layer may be chosen such as to allow for an optimal bonding to both the substrate on the one side and the template structure and/or the smoothing layer on the other side. Preferably, the base structure includes glass and/or a polymer, in particular Trivex, cellulose triacetate (TAC), cyclic olefin copolymer (COC), polyethylene terephthalate (PET), polycarbonate (PC) and/or Polymethyl methacrylate (PMMA), which is also known as acrylic glass or plexiglass. Those materials are well-known and tested materials for optical purposes and therefore particularly suited for the production of the optical structure according to the present disclosure. Preferably, within the context of particular embodiments, it is assumed and preferred that the base structure is generally flat and therefore includes a substantially flat surface area. Of course, the base structure may as well include a curved surface. All features and explanations apply equivalently in this case.

Preferably, the optical structure is produced such that in some regions, the template structure is contacting the surface of the base structure and the smoothing layer is printed on top of the template structure, whereas in other regions, the smoothing layer is printed directly on the base structure. Alternatively, the template structure may include at least one layer which substantially covers the base structure and includes specific structures at predetermined locations, in particular at locations in which microstructures are to be produced.

According to a preferred embodiment, a plurality of microstructures is printed in a predetermined pattern such that they create an optical metastructure, in particular a diffraction grating. The person skilled in the art acknowledges that a single optical microstructure may be an optical component for itself, such as a micro-lens, but may also be part of a larger optical structure or component, which includes a plurality of microstructures, such as a diffraction grating. In particular, a diffraction grating may consist of a plurality of sinusoidal or substantially rectangular ridges. It is hence particularly advantageously possible to produce (optical) diffraction gratings with very small structural sizes. It is hence advantageously possible to produce optical metastructures with very small structural sizes by means of a conventional three-dimensional printing process.

According to a preferred embodiment, the height of the microstructure includes between 1% and 50%, preferably less than 40%, more preferably less than 30%, most preferably less than 20% of the height of the template structure, e.g., the height of the template structure may be between 100 nm and 2000 nm and the height of the corresponding microstructure may then be between 1 nm and 1000 nm. Advantageously, this large range of sizes and in particular the small resulting heights of the microstructures may be achieved by controlling the smoothing layer accordingly. For example, a low viscosity of the printing ink used for printing the smoothing layer, a long curing time and/or a long waiting time, i.e., the time between printing and curing, results in microstructures with particularly small heights, as the material of the smoothing layer may more easily spread out and create a smoother outer surface, i.e., smooth out the topography created by the template structure.

According to another preferred embodiment, a lateral width of the microstructure includes between 20% and 500% of a lateral width of the template structure, preferably between 50% and 200%. The person skilled in the art acknowledges that this means that the lateral width of a microstructure may be smaller or larger than the lateral width of the corresponding template structure, e.g., the lateral width of the template structure may be between 50 microns and 500 microns, and the lateral width of the corresponding microstructure may be between 10 microns and 1000 microns.

The applicant has performed initial tests. In a first test, a substantially circular, dome-shaped template structure was printed having a height of about 1400 nm and a lateral width of about 60 microns. The smoothing layer was printed and cured such that the resulting microstructure at the location of the template structure yielded a height of about 90 nm and a lateral width of about 95 microns. In a second test, the height of the template structure was about 260 nm and the lateral width about 300 microns. The resulting microstructure had a height of about 20 nm and a lateral width of about 250 microns.

According to another preferred embodiment, in a fifth step, a coating layer is printed on top of the smoothing layer. Preferably, the coating layer is produced by means of three-dimensional printing and is preferably deposited on the smoothing layer. Such a coating layer is particularly advantageous as it may prevent damage to the optical structure from external influences. More preferably, the coating layer has a uniform thickness, in particular the coating layer has a constant thickness over its entire lateral extension. Even more preferably, the coating layer has a lower thickness than the base structure, the template structure and/or the smoothing layer. This is particularly advantageous, because in this way, the preferably merely protective coating layer does not substantially influence the optical properties of the optical structure. Preferably, the coating layer provides shielding of the optical structure against ultraviolet radiation, color correction and/or anti-reflective properties. It is herewith advantageously possible to protect the optical structure from external damaging and/or deteriorating influences. Alternatively, the smoothing layer is configured such as to act as a coating layer. This is e.g., possible by choosing material properties accordingly and/or controlling the printing and/or curing parameters for the outermost layer accordingly. It is herewith advantageously possible to create a relatively thin optical structure with protective properties without having to print an additional layer and/or to use a different printing ink for a coating layer.

A further embodiment relates to an optical structure, in particular produced by a method according as disclosed herein, where the optical structure includes a base structure, a template structure printed upon the base structure and a smoothing layer printed upon the template structure, wherein the smoothing layer includes at its outer surface at a position vertically above the template structure an optical microstructure, in particular a micro-lens, wherein the optical microstructure has a height which is lower than a height of the template structure.

According to a preferred embodiment, the base structure has a thickness which is higher than a height of the template structure and/or a maximum thickness of the smoothing layer. In particular, thickness is meant to denote a maximum or average vertical extension between two (assumed) flat planes. Preferably, the thickness of the base structure constitutes the combined thickness of a substrate and a base layer printed thereon. More preferably, the thickness of the base structure is at least two, three, five or ten times higher than the height of the template structure and/or a maximum thickness of the smoothing layer. Alternatively, a (in particular average or maximum) thickness of the smoothing layer is higher than a thickness of the base structure, in particular higher than a thickness of a base layer. It is thus advantageously possible to provide a stable base structure which allows for a precise production of the microstructures with no impact from irregularities or deformations of the base structure. Additionally or alternatively, at least the base layer is a thin and optically homogenous layer. In particular, in this context thin is to be understood as encompassing a minimal thickness which still yields the desired results, such as a good bonding with a substrate, a good bonding with the template structure and/or a mitigation of surface irregularities of the substrate. In this case of a (relatively) thin base layer, the thickness of the underlying substrate may be freely chosen, e.g., in dependence of the desired use of the optical structure. In particular, the thickness of the base layer is in the same range as the thickness of the template structure.

According to another preferred embodiment, the base structure, in particular in the region in which the template structure and/or the smoothing layer is applied, includes a smooth and/or flat upper surface. It is hence advantageously possible to prevent surface irregularities of the base structure to have a higher roughness than the height of the microstructure.

According to still another preferred embodiment, the height of the optical microstructure constitutes between 1% and 50%, preferably less than 40%, more preferably less than 30%, most preferably less than 20% of the height of the template structure, and/or in that a lateral width of the microstructure constitutes between 20% and 500% of a lateral width of the template structure, preferably between 50% and 200%.

According to a further preferred embodiment, the optical structure includes a plurality of, in particular substantially identical, optical microstructures, wherein the optical microstructures are arranged in a predetermined pattern, such that the optical structure includes an optical metastructure, in particular a diffraction grating.

According to preferred embodiments, the optical structure includes an optical waveguide having the plurality of microstructures. In particular, a plurality of microstructures creates a diffraction grating which may be used as an optical waveguide. It is hence advantageously possible to use the method to create an optical structure including an optical waveguide.

According to preferred embodiments, the optical structure includes a coating layer on top of the smoothing layer. It is hence advantageously possible to protect the optical structure from chemical and/or mechanical deterioration. Alternatively, the smoothing layer is configured such as to act as a coating layer. This is e.g., possible by choosing material properties accordingly and/or controlling the printing and/or curing parameters for the outermost layer accordingly. It is herewith advantageously possible to create a relatively thin optical structure with protective properties without having to print an additional layer and/or to use a different printing ink for a coating layer.

The present disclosure will be described with respect to a particular embodiment and with reference to the drawing. The drawing described herein is only schematic and non-limiting. In the drawing, the sizes may be exaggerated and non-proportional and may not be drawn to scale for illustrative purposes.

Where an indefinite or definite article is used when referring to a singular noun, e.g., “a”, “an”, “the”, this includes a plural of that noun unless something else is specifically stated.

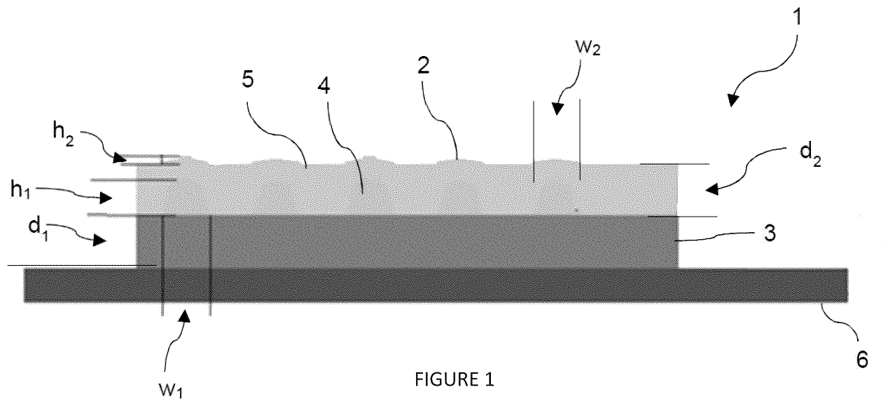

In FIG. 1, an optical structure 1 produced by a method according to an advantageous embodiment is illustrated. The method according to certain embodiments relates to a method for producing an optical structure 1 using three-dimensional printing, in particular multi-jet printing. This is a well-known method, which is consequently only described very shortly. The method employs a print head, which is known per se and therefore not shown in FIG. 1, which includes at least one, preferably a plurality of nozzles, from which droplets of a printing ink are ejected. A control unit controls the printing process and hence the droplet ejection. Furthermore, the system used for three-dimensional printing usually includes an irradiation source as well to cure the printing ink once it is deposited as desired. The printing ink is ejected in droplets which are deposited at least partially side by side to create a layer, and at least partially on top of each other to create subsequent layers. The printing ink preferably includes a translucent or transparent component. More preferably, the printing ink includes at least one photo-polymerizable component. The at least one photo-polymerizable component is most preferably a monomer that polymerizes upon exposure to radiation, e.g., ultra-violet (UV) light. The deposited droplets are preferably pin cured, i.e., partially cured, after deposition.

The inventive method includes providing a suitable base structure 3 in a first step. This base structure 3 may be a conventional substrate, a lens blank, a printed base layer or a combination thereof. For example, providing the base structure 3 could include providing a substrate and printing a smooth base layer thereon. This is particularly advantageous as the structural size, in particular the height h2, of the optical microstructure(s) 2 to be produced is so small that a high roughness of the base structure surface might negatively impact the effect of the microstructures.

Optionally, if the base structure 3 includes at least one printed layer, during and/or after printing, a curing sub-step might ensue, in which the printed layer(s) is at least partially cured.

After providing the base structure 3 in the first step, a template structure 4 is printed on the base structure 3 in a second step. The template structure 4 preferably includes the general shape of the desired optical microstructure 2 but has in particular a larger height h1. According to the exemplary embodiment depicted in FIG. 1, not only one, but five substantially identical template structures 4 are printed. Preferably, during and/or after printing, the template structures 4 are at least partially cured.

In a subsequent third step, a smoothing layer 5 is printed on the base structure 3 and/or on the template structures 4. The smoothing layer 5 is preferably printed using a printing ink with different properties than that used for printing the template structure 4. In particular, the properties of the printing ink for the smoothing layer 5 are chosen such that e.g., its viscosity is lower and/or its curing time is longer than that of the printing ink used for printing the template structure 4. Alternatively, the same printing ink is used for the smoothing layer and the template structure, but at least one parameter of the printing process and/or the curing process is altered. In particular, at least one parameter of the second step and/or the third step is chosen such as to yield the predetermined microstructure.

The smoothing layer 5 is applied such that it partially smooths the topography created by the template structures 4. It is important to note that the topography is not completely smoothened out. In the regions where the template structures 4 are located, the smoothing layer 5 has a higher vertical extension compared to the adjacent regions. Hence, the outer, i.e., the upper, surface of the smoothing layer 5 includes structures with a general profile corresponding to the one of the template structures 4, but with much lower heights h2, measured from the general flat upper surface of the smoothing layer 5.

Thus, optical microstructures 2 are created in the smoothing layer 5. In particular, the height h2 of the optical microstructures may be, e.g., between 1% and 30% of the height h1 of the underlying template structure 4.

Depending on the printing process, the printing ink properties and/or the curing process, the width, i.e., the lateral width w2 in the plane of the smoothing surface plane, of the optical microstructures 2 may be smaller or larger than the lateral width w1 of the template structure 4. In particular, the lateral width w2 of the optical microstructure may constitute between 50% and 200% of the lateral width w1 of the template structure.

Preferably, the template structure 4 and the smoothing layer 5 are printed using different inks, e.g., the smoothing 5 layer is printed using an ink which includes a lower viscosity and/or a longer curing time than the ink used for the template structure 4. Notwithstanding the above, the ink used for printing the smoothing layer 5 is preferably similar enough to the one used for printing the template structure 4, e.g., including the same color and substantially the same optical properties, that a good bonding is achieved between the template structure 4 and the smoothing layer 5. In particular, the refractive indices of both inks are substantially identical such that the interface between both layers preferably does not count as an interface between different media with regard to refraction. In this regard, it is much preferred if both the template structure 4 and the smoothing layer 5 and in particular the base structure 3 is at least partially translucent and/or transparent.

Preferably, the base structure has a thickness d1, which is higher than a height of the template structure h1 and/or a maximum thickness of the smoothing layer d2. In particular, thickness is meant to denote a maximum or average vertical extension between two (assumed) flat planes. Preferably, the thickness of the base structure d1 constitutes the combined thickness of a substrate and that of a base layer printed thereon. More preferably, the thickness of the base structure d1 is at least two, three, five or ten times higher than the height of the template structure h1 and/or a maximum thickness of the smoothing layer d2. Alternatively, it is also conceivable that a (in particular average or maximum) thickness of the smoothing layer d2 is higher than a thickness of the base structure d1. Additionally or alternatively, at least the base layer is a thin and optically homogenous layer. In particular, in this context thin is to be understood as encompassing a minimal thickness which still yields the desired results, such as a good bonding with a substrate, a good bonding with the template structure and/or a mitigation of surface irregularities of the substrate. In this case of a (relatively) thin base layer, the thickness of the underlying substrate may be freely chosen, e.g., in dependence of the desired use of the optical structure.

Optionally, in a further step, which is not depicted here, a protective coating layer may be applied to the smoothing layer 5. The coating layer preferably has a uniform, i.e., constant, thickness. The coating layer may provide a color correction for the lens and/or it may provide UV protection, mechanical protection, chemical protection and/or anti-reflective properties.

It is noted that in particular the relative thicknesses and/or heights of the base structure, the template structure and the smoothing layer are not drawn to scale. In particular, the template structure is usually much smaller compared to the smoothing layer and/or the base structure.

What is claimed is:

1. A method, wherein:
in a first step, a base structure is provided;
in a second step, at least one template structure is printed on the base structure; wherein the template structure is built up from at least one layer of printing ink deposited through targeted placement of droplets of printing ink at least partially side by side;
in a third step, a smoothing layer is printed at least on top of the template structure, wherein the smoothing layer is built up from at least one layer of printing ink deposited through targeted placement of droplets of printing ink at least partially side by side;
in a fourth step, the smoothing layer is cured, wherein during the third step and/or the fourth step, parameters of the printing and/or the curing are chosen such that the smoothing layer comprises on its outer surface an optical microstructure at a position vertically above the template structure, wherein the optical microstructure comprises a height (h2) which is lower than a height of the template structure.

2. The method of claim 1, wherein parameters of printing the template structure or the smoothing layer comprise at least one of an ambient temperature, a temperature of the printing ink, a composition of the printing ink, a viscosity of the printing ink, a droplet size, a droplet ejection velocity, a droplet density, and a printing velocity, and/or wherein parameters of curing the smoothing layer comprise at least one of a curing temperature, a curing time, an irradiation intensity, and an irradiation wavelength.

3. The method of claim 1, wherein the base structure is a substrate, a lens blank and/or a three-dimensionally printed structure.

4. The method of claim 1, wherein a plurality of the microstructures are printed in a predetermined pattern such that they create an optical metastructure.

5. The method of claim 4, wherein the optical metastructure comprises a diffraction grating.

6. The method of claim 1, wherein a height of the microstructures comprises between 1% and 50% of a height of the template structure.

7. The method of claim 7, wherein the height of the microstructures comprises less than 20% of the height of the template structure.

8. The method of claim 1, wherein a lateral width of the microstructure comprises between 20% and 500% of a lateral width of the template structure.

9. The method of claim 1, wherein in a fifth step, a coating layer is printed on top of the smoothing layer.

10. The method of claim 1, wherein in an additional step between the second step and the third step, the template structure is at least partially cured.

11. The method of claim 1, wherein a different ink is used for printing the smoothing layer and for printing the template structure.

12. An optical structure comprising:
a base structure;
a template structure printed upon the base structure; and
a smoothing layer printed upon the template structure, wherein the smoothing layer comprises at its outer surface at a position vertically above the template structure an optical microstructure having a height which is lower than a height of the template structure.

13. The optical structure of claim 12, wherein the base structure comprises a thickness which is higher than a height of the template structure and/or a maximum thickness of the smoothing layer.

14. The optical structure of claim 12, wherein a height of the optical microstructure comprises between 1% and 50% of a height of the template structure.

15. The optical structure of claim 14, wherein the height of the optical microstructure comprises less than 20% of the height of the template structure.

16. The optical structure of claim 12, wherein a lateral width of the microstructure comprises between 20% and 500% of a lateral width of the template structure.

17. The optical structure of claim 12, comprising a plurality of substantially identical optical microstructures forming a diffraction grating.

18. The optical structure of claim 12, further comprising a coating layer on top of the smoothing layer.

19. An optical waveguide comprising the optical structure of claim 12.
